(19) United States
(12) Patent Application Publication
(10) Pub. No.: US 2023/0139213 A1
(43) Pub. Date: May 4, 2023

(54) COMPUTING DEVICE AND RELATED METHODS FOR COMPUTING SESSION PROTECTION

(71) Applicant: CITRIX SYSTEMS, INC., FORT LAUDERDALE, FL (US)

(72) Inventors: ZONGPENG QIAO, Nanjing (CN); KE XU, Nanjing (CN); DAN HU, Nanjing (CN); ZE CHEN, Nanning (CN)

(21) Appl. No.: 17/643,253

(22) Filed: Dec. 8, 2021

Related U.S. Application Data
(63) Continuation of application No. PCT/CN2021/127314, filed on Oct. 29, 2021.

(51) Int. Cl. G06F 21/62; G06V 40/16; H04L 12/18; H04L 65/1089

(52) U.S. Cl. CPC G06F 21/6263; G06V 40/172; H04L 12/1822; H04L 65/1089

(57) ABSTRACT

A computing device may include a memory and a processor coupled to the memory and configured to provide access to a computing session for a user through a user interface, and cooperate with a digital camera to detect activity other than that of the user in a field of view. Responsive to the detection, the processor may further block input of data to the user interface and permit viewing of the user interface. Responsive to an attempt to input data via the user interface, the processor may continue to block input of data and obstruct viewing of the user interface.

### RELATED APPLICATIONS

This application is a continuation of PCT application serial no. PCT/CN2021/127314 filed Oct. 29, 2021, which is hereby incorporated herein in its entirety by reference.

### BACKGROUND

Web applications or apps are software programs that run on a server and are accessed remotely by client devices through a Web browser. That is, while Web applications have a similar functionality to native applications installed directly on the client device, Web applications are instead installed and run on the server, and only the browser application is installed on the client device. Although in some implementations, a hosted browser running on a virtualization server may be used to access Web applications as well.

One advantage of using Web applications is that this allows client devices to run numerous different applications without having to install all of these applications on the client device. This may be particularly beneficial for thin client devices, which typically have reduced memory and processing capabilities. Moreover, updating Web applications may be easier than native applications, as updating is done at the server level rather than having to push out updates to numerous different types of client devices.

Software as a Service (SaaS) is a Web application licensing and delivery model in which applications are delivered remotely as a web-based service, typically on a subscription basis. SaaS is used for delivering several different types of business (and other) applications, including office, database, accounting, customer relation management (CRM), etc.

### SUMMARY

A computing device may include a memory and a processor coupled to the memory and configured to provide access to a computing session for a user through a user interface, and cooperate with a digital camera to detect activity other than that of the user in a field of view. Responsive to the detection, the processor may further block input of data to the user interface and permit viewing of the user interface. Responsive to an attempt to input data via the user interface, the processor may continue to block input of data and obstruct viewing of the user interface.

In an example embodiment, the processor may be further configured to display an input element for the user interface, and discontinue blocking input data via the user interface responsive to input received via the input element. For example, the processor may be configured to temporarily discontinue blocking input data via the user interface responsive to input received via the input element. In some embodiments, the processor may obstruct viewing of the user interface by changing an opacity of the user interface.

The activity detected in the field of view may be from another person than the user or animal, for example. In an example implementation, the processor may be configured to detect the activity based upon facial recognition. The processor may also be configured to perform initial processing on data received from the digital camera, and based on the initial processing, cooperate with a remote computing device to detect the activity, for example. Also by way of example, the processor may be configured to block input of data to the user interface by at least one of the digital camera, a keyboard and a mouse.

A related method may include, at a computing device, providing access to a computing session for a user through a user interface, and cooperating with a digital camera having a field of view for detecting activity in the field of view other than that of the user. Responsive to the detection, input of data to the user interface may be blocked while permitting viewing of the user interface. Responsive to an attempt to input data via the user interface, input of data may continue to be blocked, and viewing of the user interface may be obstructed.

A related non-transitory computer-readable medium may have computer-executable instructions for causing a computing device to perform steps including providing access to a computing session for a user through a user interface, and cooperating with a digital camera having a field of view for detecting activity in the field of view other than that of the user. The steps may further include, responsive to the detection, blocking input of data to the user interface and permit viewing of the user interface, and responsive to an attempt to input data via the user interface, continuing to block input of data and obstructing viewing of the user interface.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web-based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing device providing user interface viewing and data input protection features during computing sessions in accordance with an example embodiment.

FIG. 7 is a schematic block diagram illustrating activity detection by the system of FIG. 6 in accordance with an example embodiment.

FIGS. 8-10 are a series of user interface views showing operation of the computing system of FIG. 6 in an example implementation for an online collaboration session.

FIG. 11 is a schematic block diagram of an example implementation of the system of FIG. 6 using the workspace network architecture of FIG. 5.

FIG. 12 is a sequence flow diagram illustrating operational aspects associated with the configuration of FIG. 11.

FIG. 13 is a flow diagram illustrating method aspects associated with the system of FIG. 6.

### DETAILED DESCRIPTION

Working from home or remotely is becoming increasingly common. In order to allow collaboration between employees and others outside the office, various meeting and collaboration tools such as Zoom, Teams, Slack, etc., are used to permit communication between people in different locations as needed. However, working at home introduces the opportunity for interruptions from children or pets during a computing session (e.g., a meeting), or undesired input to a chat session, for example. This may take the form of a child or pet in the field of view of the user's camera during an online meeting, entering nonsense characters on a keyboard, or unmuting a microphone by accident.

The present approach provides a technical solution to these problems through a computing device that uses an image capture device (e.g., a digital camera) having a field of view to detect activity other than that of the user. Responsive to the detection, the processor may block input of data to or with use of the user interface for the computing session (e.g., a collaboration), yet still permit viewing of the user interface without interruption until the user attempts to input data via the user interface, at which time viewing of the user interface may be obstructed to inform the user that data input has been blocked. This allows the user to continue to view the session, yet helps avoid the risk of inadvertent or unexpected input of data via the digital camera, keyboard, a touchscreen and a mouse, for example.

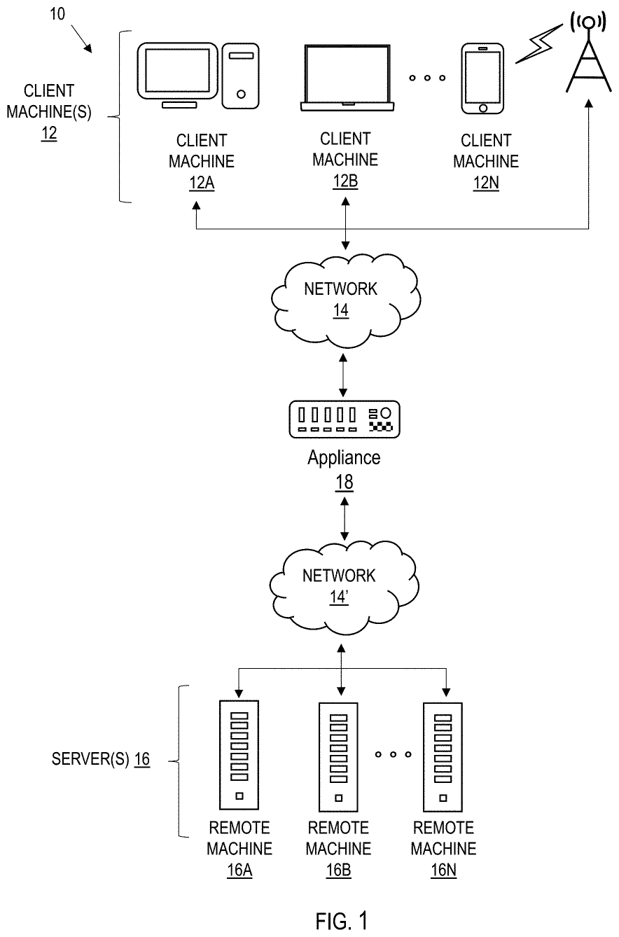

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 108 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

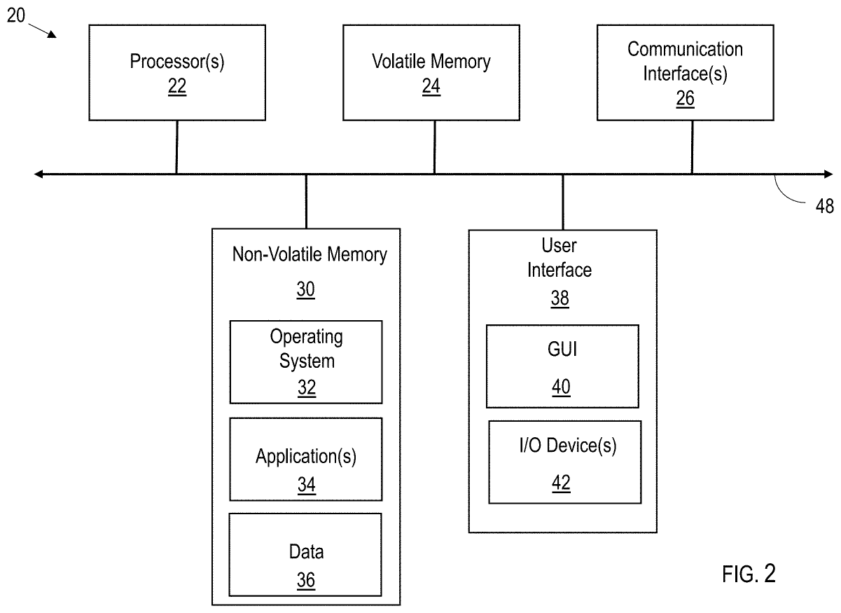

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Fla. (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

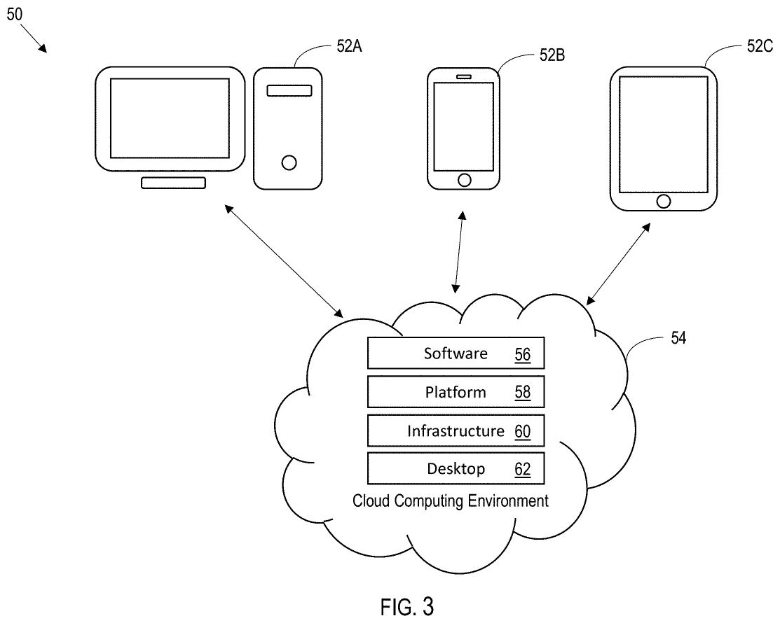

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

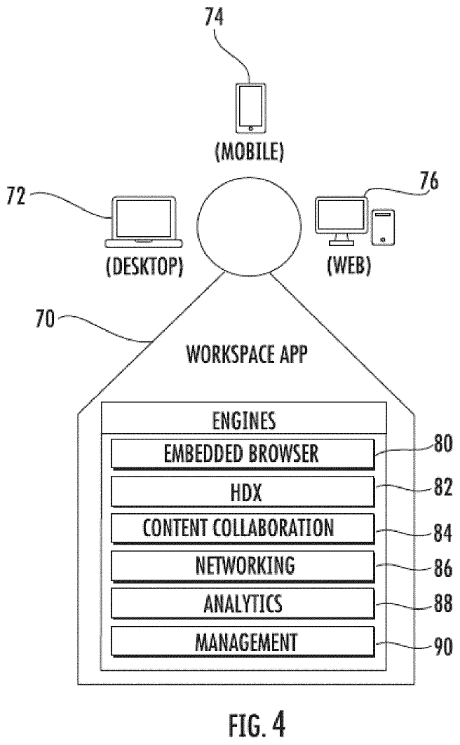

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific μ-VPN connection. A μ-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

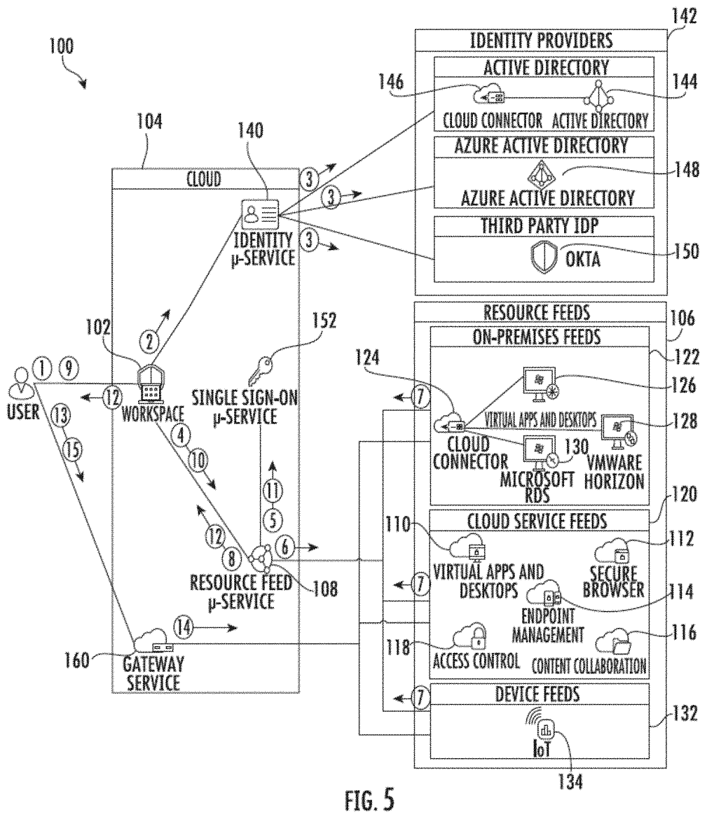

Referring now to FIG. 5, a workspace network environment 100 providing a unified experience to a user based on the workspace app 70 will be discussed. The desktop, mobile and web versions of the workspace app 70 all communicate with the workspace experience service 102 running within the Cloud 104. The workspace experience service 102 then pulls in all the different resource feeds 16 via a resource feed micro-service 108. That is, all the different resources from other services running in the Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Cloud 104, and presenting their identity (event 1). The identity includes a username and password, for example.

The workspace experience service 102 forwards the user's identity to an identity micro-service 140 within the Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

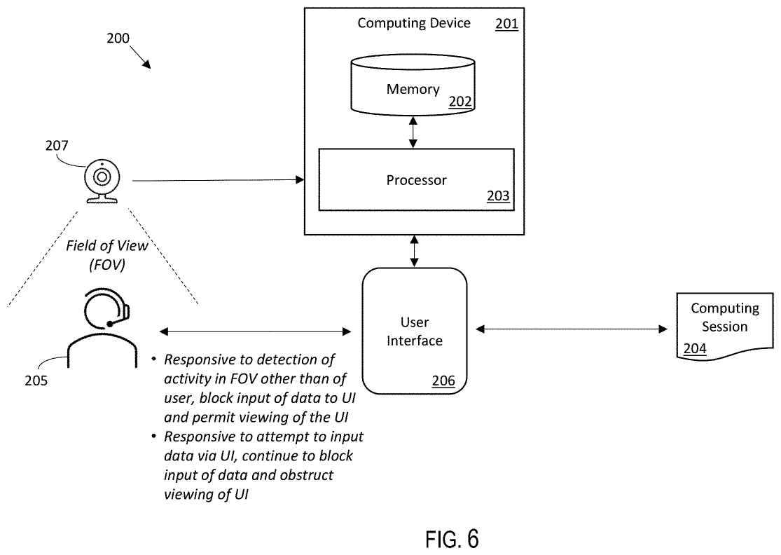

Turning now to FIG. 6, a computing system 200 is provided which allows a user to participate in a computing (e.g., collaboration) session 204 while providing protection from unexpected input by others to the computing session. The system 200 illustratively includes a computing device 201 including a memory 202 and a processor 203. By way of example, the computing device 201 may be a client device (e.g., smartphone, tablet computer, desktop computer, laptop computer, etc.) as discussed above. The processor 203 is configured to provide access to a computing session 204 for a user 205 through a user interface (UI) 206. The computing session 204 may be a remotely hosted session (e.g., a SaaS or Web app), and in the case of a collaboration session may allow video, audio, and/or text exchanges between users logged into the session. Examples of such collaboration platforms/apps include Zoom, Teams, GoToMeeting, WebEx, Slack, etc., although others may be used in different embodiments.

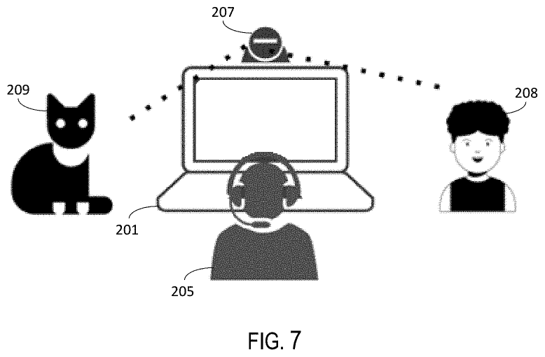

The processor 203 further cooperates with a digital camera 207 having a field of view (FOV) to detect activity in the field of view other than that of the user. As noted above, when working from home, such activity may come from children 208 or pets 209 that unexpectedly show up during a collaboration session or meeting (see FIG. 7), although the activity may come from other sources as well (e.g., passers-by, moving objects in the background, etc.). Responsive to such a detection, the processor 203 will enter a protected or “sentry” mode in which it blocks input of data to (or via) the user interface 206, yet while still permitting viewing of the user interface. By way of example, the input data that is blocked may be from one or more of a microphone, keyboard, mouse, track pad, touchscreen and the camera 207, or other input devices in some embodiments. In this way, the user 205 is able to continue viewing the collaboration session, yet the risk of accidental or unintended input to the collaboration session is prevented by the processor.

If the user 205 attempts to input data via the user interface 206 after the activity detection noted above, the processor 203 blocks input of data to the user interface but then also obstructs viewing of the user interface. This provides a visual indication to the user 205 that the computing session 204 is being displayed in the sentry mode of operation where input to the user interface 206 is blocked.

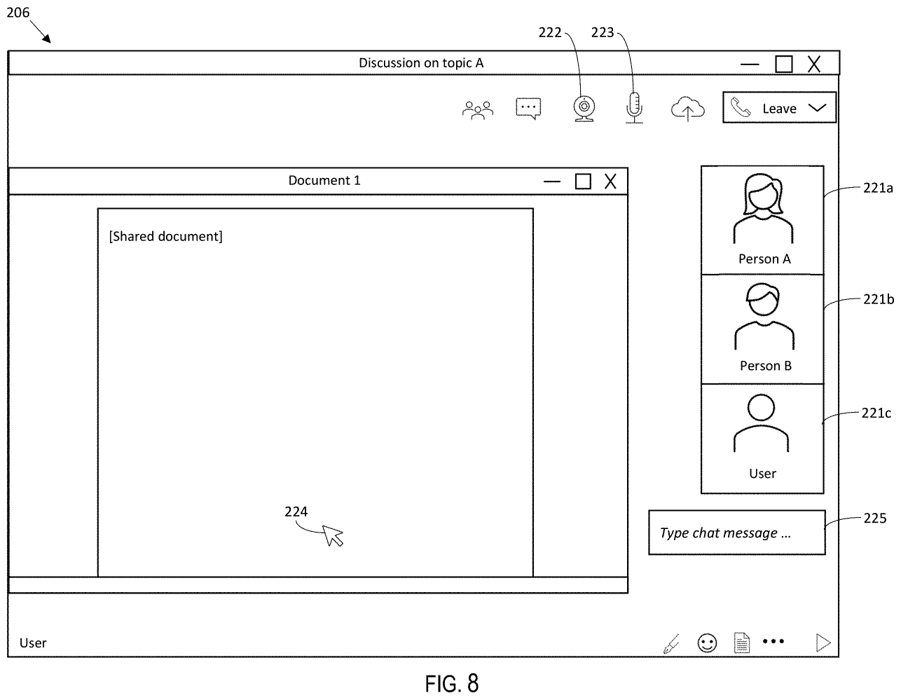

The foregoing will be further described with reference to an example now described with reference to FIGS. 8-10. In the illustrated example, a user (User) is participating in an online meeting session through the user interface 206, which is displayed in a window, and two other people or participants (Person A and Person B) are in attendance. Video feeds of People A and B and the User are shown in respective video boxes 221a-221c. In the online meeting, a document (Document 1) is being shared for viewing by the participants. In the view shown in FIG. 8, the processor 203 is operating in a normal mode in which the user interface 206 is not obstructed, and input to the user interface 206 is not blocked. In this example, input to the user interface 206 may come from the camera 207 (as indicated by a camera icon 222), which is shown in the video box 221c, a microphone (as indicated by a mic icon 223), a mouse/track pad (as indicated by a pointer 224), or a keypad/keyboard (as indicated by a chat box 225).

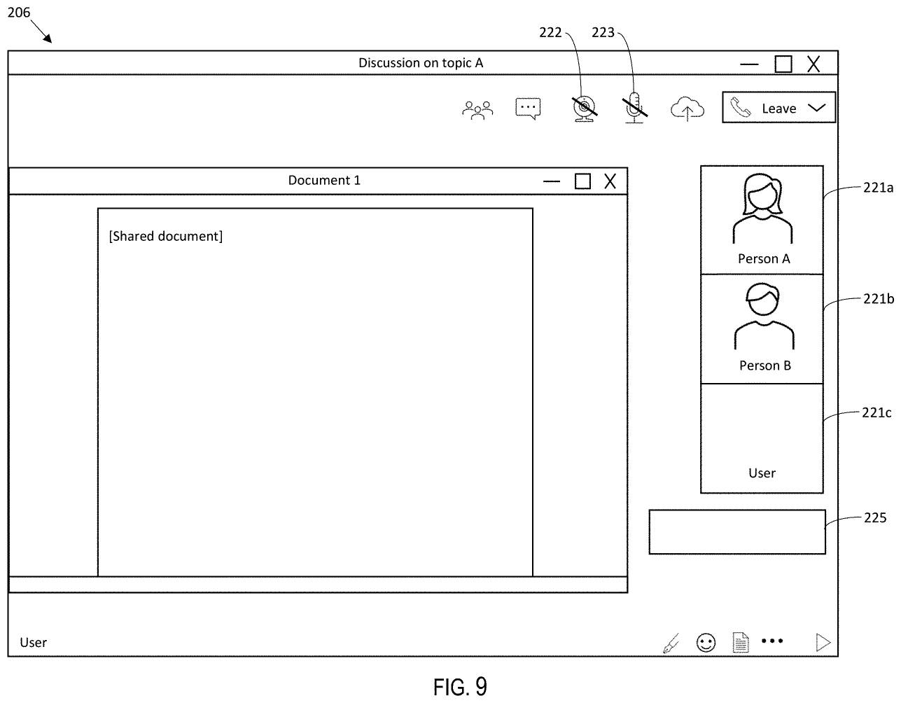

At a later time during the meeting (shown in FIG. 9), the processor 203 detects (e.g., automatically detects) activity in the field of view of the camera 207 that is not from the user. By way of example, this could be done through a combination of motion detection and facial recognition. When movement is detected, if the user's face is not detected where the movement is, then the activity will be determined to be from a source other than the user. Upon detection of the activity, the processor 203 enters (e.g., automatically enters) the sentry mode and disables input to the user interface 206. However, the view of the user interface remains unobscured and appears substantially the same as in the normal mode (shown in FIG. 8), allowing the user to continue to see and hear the other participants in the meeting, as well as view the shared document through the user interface.

In some embodiments, queues may be provided on the unobscured user interface 206 to indicate that data input has been blocked. In the example shown in FIG. 9, this is accomplished with the lines that appear through the camera and mic icons 222, 223. Moreover, the video feed of the user disappears from the video box 221, and the message “Type chat message . . . ” disappears from the chat box 225, as input from the camera 207 and keyboard are also blocked from input to the user interface 206.

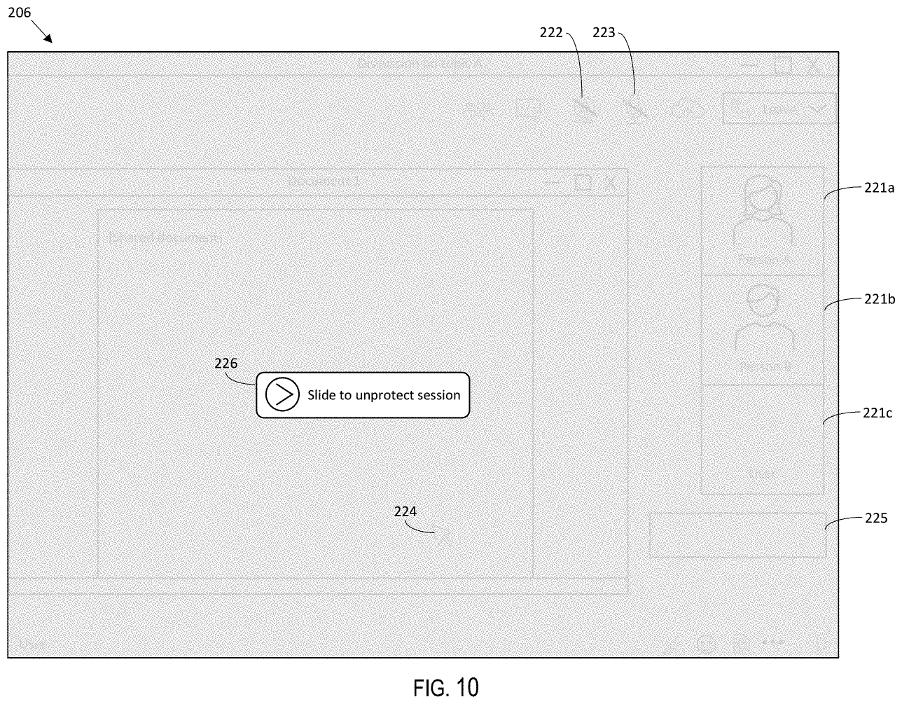

When the processor 203 is still in sentry mode and the user attempts to provide input to the user interface (here moving the pointer 224 over top of the user interface), the processor 203 then obscures the view of the user interface (FIG. 10). In the present example, this is achieved through a semi-transparent or semi-opaque overlay on the user interface 206, i.e., changing the opacity of the user interface. This provides an immediate representation to the user to inform or remind him that the user interface 206 is in the sentry mode, and that data input is disabled. However, in the illustrated example, an input element 226 (here a slider) is provided to allow the user to disable data input blocking. This may be done temporarily, for example, and the processor 203 remains in sentry mode until the activity is no longer detected by the camera 207, or the user manually discontinues it (e.g., through a menu, etc.). Here, the user slides to unprotect the session, allowing temporary operation within the session (as shown in FIG. 8). If there is no interaction for a period of time (e.g., a predetermined time, such as 15 seconds), the processor 203 may then re-protect the session by blocking input data. In some embodiments, a manual option (e.g., menu selection) may be provided to disable the sentry mode completely and stop input data blocking, even where continued activity from a source other than the user is detected via the camera 207.

Otherwise, the processor 203 may continue to monitor the activity detected in the field of view of the camera 207, until such time as no further activity is detected from a source other than the user. The processor 203 may then disable (e.g., automatically disable) the sentry mode, and return to monitoring the field of view for non-user activity while the computing device functions or otherwise runs in an unprotected mode of operation.

In some embodiments, the sentry mode may be manually triggered (e.g., through a menu or button selection) without a detection of non-user activity in the field of view. For example, if a user wants to perform other activities with the computing device 201 (e.g., checking emails, placing a phone call, etc.) but does not want to risk accidentally directing such input to the user interface 206 (and, thus, the collaboration session), then the sentry mode could be manually engaged until the user wishes to return to providing input to the meeting.

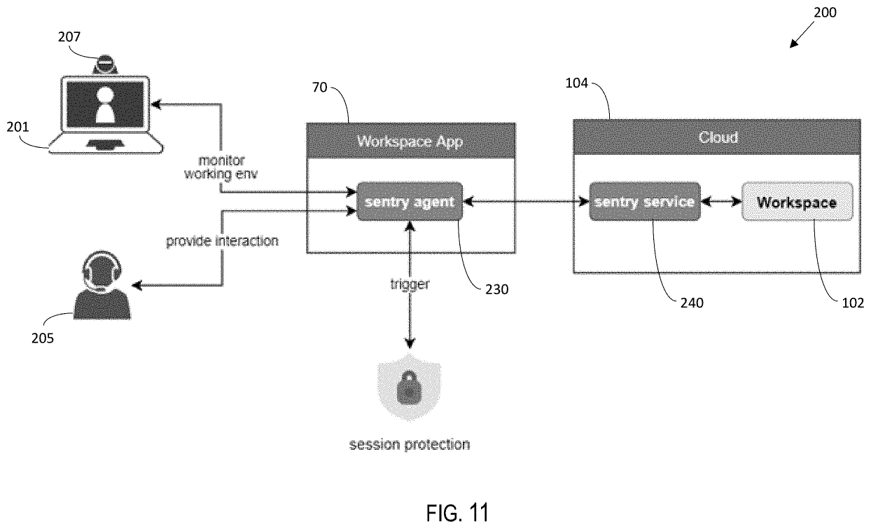

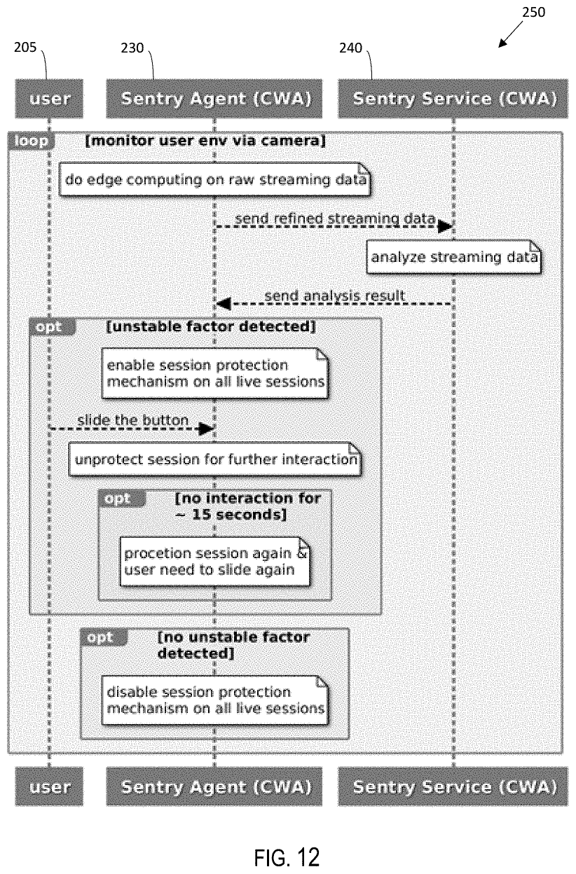

Turning now to FIG. 11 and the sequence flow diagram 250 of FIG. 12, an example implementation of the system 200 using the workspace app 70 and the workspace experience service 102 in the cloud 200 is now described. To provide the automatic sentry mode detection and protection, two additional components are added, namely a sentry agent 230 in the workspace app 70, and a sentry service 240 to accompany the workspace experience service 102 in the remote computing service 304. When the user opens designated computing sessions, (e.g., Independent Computing Architecture (ICA) sessions for collaboration tools or apps), the sentry agent 230 will begin to work. The sentry agent 230 monitors the environment in the field of view of the camera 207, and in the present example performs some initial processing (e.g., edge computing) on the original image data from the camera, as will be discussed further below. The sentry agent 230 sends the video (e.g., processed video) or image data to the sentry service 240. The sentry service 240 then performs image processing (e.g., motion detection, facial recognition, etc.), and determines when to enable/disable the sentry mode based on the analysis result. Once sentry mode is enabled, the sentry service 240 may cause the sentry agent 230 to trigger session protection, as discussed further above.

More particularly, the sentry service 240 analyzes data from the sentry agent 230 to generate a conclusion on whether the environment is “stable”, that is, whether there is activity present from someone or something other than the user. Once the sentry agent 230 is loaded, it will start monitoring the user's environment through the field of view of the camera 207. The sentry agent 230 may first leverage edge computing technology to refine the raw streaming data from the camera 207 to facilitate transmission to the sentry service 240. This may be beneficial to help improve performance such as through trimming duplicate data before sending, for example. The sentry service 240 analyzes the refined data, and then sends its analysis results to the sentry agent 230. If unstable activity is detected, the sentry agent 230 enables the sentry mode and session input data protection on one or more opened sessions on device 201. In some embodiments, all of the collaboration apps may be protected by default, and a user may be provided with the ability to dynamically choose other opened sessions to protect as well. By way of example, a user may have more than one collaboration app open (e.g., Teams and Slack), and the sentry agent 230 may block input to one or both of these open apps (which may be native or hosted) when sentry mode is enabled. For sessions hosted in a browser, browser extensions may be used to render a similar effect and host similar logic with respect to the native application. However, the sentry agent 230 may still allow other local applications (e.g., word processor, email, etc.) besides the collaboration application(s) to operate normally during sentry mode, for example. This may be achieved by detecting which app is on the top or active in the OS system and whether it is a local app or collaboration app, and then operating accordingly.

As discussed further above, if the user wants to unprotect a session, he can do so manually as discussed above with reference to FIG. 10 (e.g., slide to unprotect the session). The user can then temporarily operate normally in the session. If there is no interaction for a period of time (e.g., fifteen seconds) and unstable activity continues to be detected, the sentry agent 230 will re-protect the session from data input once again. Once no unstable activity is detected, the sentry agent 230 will exit the sentry mode and disable data input protection on the opened session(s).

The use of edge computing by the sentry agent 230 compresses the size of the video/image data, which helps reduce bandwidth consumption and enhances communications with the sentry service 240. In one example embodiment, the edge processing may be performed using open source library OpenCV to perform image compression. Using the example of OpenCV, the resize function in OpenCV may be used to convert the image to a smaller size as follows:
void resize (InputArray src, OutputArray dst, Size dsize, double fx=0, double fy=0, int interpolation=INTER_LINEAR)
Furthermore, the cvCvtColor function in OpenCV may be used to convert the image From RGB to Gray as follows:
cvCvtColor(IplImage*src, IplImage*dst, CV_BRG2GRAY).
   However, it should be noted that other suitable edge processing techniques may also be used in different embodiments.

After edge computing is performed by the sentry agent 230, the compressed image is transferred to the sentry service 240, and methods for additional or further data processing such as Region-CNN may be used to detect how many items are in the compressed image. As noted above, such items may include human beings or pets. If only one user is present in the image, the sentry service 240 once again leverages a match function in OpenCV to check if this is the correct or otherwise authorized user. If the user is correct, the sentry service 240 will send a result reporting a stable environment to the sentry agent 230. If not, the sentry service 240 will send a result reporting an unstable environment to the sentry agent 230. The machine learning techniques (e.g., techniques that include use of a trained model, may be applied to perform image detection and recognition directly.

The workspace experience service 102 can leverage the above-described approach to provide smart session protection features in multiple collaboration scenarios. However, in some embodiments, these features may be implemented independently of the workspace environment. For example, a sentry agent 230 could be built directly into a collaboration tool like Teams or Slack (or other applications) to apply similar sentry mode functionality and an enhanced communication experience, or as a plugin or background agent. It should also be noted that in some embodiments, other input such as microphone input may also be used in addition to (or instead of) the camera 207 to monitor the user's environment and determine when non-user activity is present. For example, voice recognition techniques or methods may be used to identify when detected audio is from the user or not.

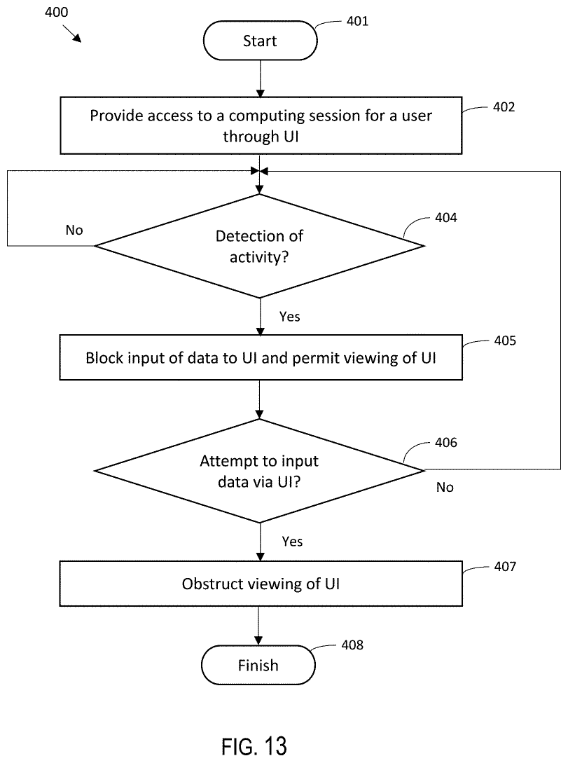

Referring additionally to the flow diagram 400 of FIG. 13, a related method is now described. Beginning at Block 401, the method may include, at the computing device 201, providing access to a computing session 204 for the user 205 through the user interface 206, at Block 402, and cooperating with the digital camera 207 for detecting activity in the field of view other than that of the user, at Block 404. Responsive to the detection, input of data to the user interface 206 may be blocked while permitting viewing of the user interface, as described further above with reference to FIG. 9 (Block 405). Responsive to an attempt to input data via the user interface 206, at Block 406, input of data may continue to be blocked, and viewing of the user interface also may be obstructed, at Block 407. As discussed further above, this allows the user interface 206 to be viewed normally by the user 205 so that he may continue to receive audio/visual data from the computing session (e.g., collaboration session), but obstructs the user interface when the user attempts to provide input to the computing session so that the user is informed or reminded that his input to the conference session is blocked. The method of FIG. 13 illustratively concludes at Block 408.

As will be appreciated by one of skill in the art upon reading the foregoing disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing device comprising:
a memory and a processor coupled to the memory and configured to
provide access to a computing session for a user through a user interface,
cooperate with a digital camera to detect activity other than that of the user in a field of view,
responsive to the detection, block input of data to the user interface and permit viewing of the user interface, and
responsive to an attempt to input data via the user interface, continue to block input of data and obstruct viewing of the user interface.

2. The computing device of claim 1 wherein the process is further configured to display an input element for the user interface, and discontinue blocking input data via the user interface responsive to input received via the input element.

3. The computing device of claim 2 wherein the processor is configured to temporarily discontinue blocking input data via the user interface responsive to input received via the input element.

4. The computing device of claim 1 wherein the processor obstructs viewing of the user interface by changing an opacity of the user interface.

5. The computing device of claim 1 wherein the activity detected in the field of view is from another person other than the user or animal.

6. The computing device of claim 1 wherein the processor is configured to detect the activity based upon facial recognition.

7. The computing device of claim 1 wherein the processor is configured to perform initial processing on data received from the digital camera, and based on the initial processing cooperate with a remote computing device to detect the activity.

8. The computing device of claim 1 wherein the processor is configured to block input of data to the user interface by at least one of the digital camera, a keyboard, a touchscreen and a mouse.

9. A method comprising:
at a computing device,
providing access to a computing session for a user through a user interface,
cooperating with a digital camera for detecting activity other than that of the user in a field of view,
responsive to the detection, blocking input of data to the user interface and permitting viewing of the user interface, and
responsive to an attempt to input data via the user interface, continuing to block input of data and obstructing viewing of the user interface.

10. The method of claim 9 further comprising displaying an input element for the user interface, and discontinuing blocking input data via the user interface responsive to input received via the input element.

11. The method of claim 10 wherein discontinuing comprises temporarily discontinuing blocking input data via the user interface responsive to input received via the input element.

12. The method of claim 9 wherein obstructing comprises obstructing viewing of the user interface by changing an opacity of the user interface.

13. The method of claim 9 wherein the activity detected in the field of view is from another person other than the user or animal.

14. The method of claim 9 wherein detecting comprises detecting the activity based upon facial recognition.

15. The method of claim 9 further comprising, at the computing device, performing initial processing on data received from the digital camera, and based on the initial processing cooperating with a remote computing device to detect the activity.

16. A non-transitory computer-readable medium having computer-executable instructions for causing a computing device to perform steps comprising:
providing access to a computing session for a user through a user interface;
cooperating with a digital camera having a field of view for detecting activity in the field of view other than that of the user;
responsive to the detection, blocking input of data to the user interface and permitting viewing of the user interface; and
responsive to attempt to input data via the user interface, continuing to block input of data and obstructing viewing of the user interface.

17. The non-transitory computer-readable medium of claim 16 further having computer-executable instructions for causing the computing device to display an input element for the user interface, and discontinue blocking input data via the user interface responsive to input received via the input element.

18. The non-transitory computer-readable medium of claim 16 wherein the activity detected in the field of view is from another person than the user or animal.

19. The non-transitory computer-readable medium of claim 16 wherein detecting comprises detecting the activity based upon facial recognition.

20. The non-transitory computer-readable medium of claim 16 further having computer-executable instructions for causing the computing device to perform initial processing on data received from the digital camera, and based on the initial processing, cooperate with a remote computing device to detect the activity.
